(19) United States
(12) Patent Application Publication
(10) Pub. No.: US 2023/0041425 A1
(43) Pub. Date: Feb. 9, 2023

(54) Hygiene Mobile Van

(71) Applicant: Jermaine Stewart, LA, CA (US)

(72) Inventor: Jermaine Stewart, LA, CA (US)

(21) Appl. No.: 17/397,588

(22) Filed: Aug. 9, 2021

(51) Int. Cl. B60R 13/08; B60R 15/02; B60R 15/04; B60H 3/06

(52) U.S. Cl. CPC B60R 13/0823; B60R 15/02; B60R 15/04; B60H 3/0658

(57) ABSTRACT

The disclosure is the only product of its kind that takes the generic concept of a recreational vehicle and modifies it to accommodate the busy lives of the modern-day individual. The disclosure is uniquely designed to offer optimal storage opportunities and living quarters that provides consumers a means of transport and a means to get clean and presentable for any occasion, while on the go. The disclosed hygiene mobile van includes a sanitary curtain configured to hermetically seal off a front cab space from a personal hygiene space in an inside of the van vehicle. A sanitary cover for each fomite in the personal hygiene space is applied thereto inside of the hygiene mobile van, wherein a fomite having a water transfer there through defines a drain therein. The disclosure also includes a HVAC ventilation for the personal hygiene space separate from a HVAC ventilation for the front cab space.

### BACKGROUND

In today's modern world, many people are tasked with several responsibilities that require their daily attention. This can be challenging for many individuals to have time for basic hygiene needs, especially those who have limited time between obligations. There have been no products available as original equipment or as an aftermarket to address this problem.

A system for helping individuals find the necessary time for basic hygiene necessities, amid their busy schedules. There have been no products available as original equipment or as an aftermarket to address this problem either.

There exists a need for a device and a system such as the Hygiene Mobile Van that is not being met by any known or disclosed device or system of present.

### SUMMARY OF THE INVENTION

Hygiene Mobile Van is to serve as a hygiene mobile unit on wheels which caters to those who have to complete multiple obligations in a limited amount of time. Thus allowing users the ability to fulfill their basic hygienic needs with tight and busy schedules.

The disclosed hygiene mobile van includes a sanitary curtain configured to hermetically seal off a front cab space from a personal hygiene space in an inside of the van vehicle. A sanitary cover for each fomite in the personal hygiene space is applied thereto inside of the hygiene mobile van, wherein a fomite having a water transfer there through defines a drain therein. The disclosure also includes a HVAC ventilation for the personal hygiene space separate from a HVAC ventilation for the front cab space.

### BRIEF DESCRIPTION OF THE DRAWINGS

FIG. 1 is a top elevational view of Hygiene Mobile Van in accordance with an embodiment of the present disclosure.

FIG. 2 is a side elevational view of Hygiene Mobile Van in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

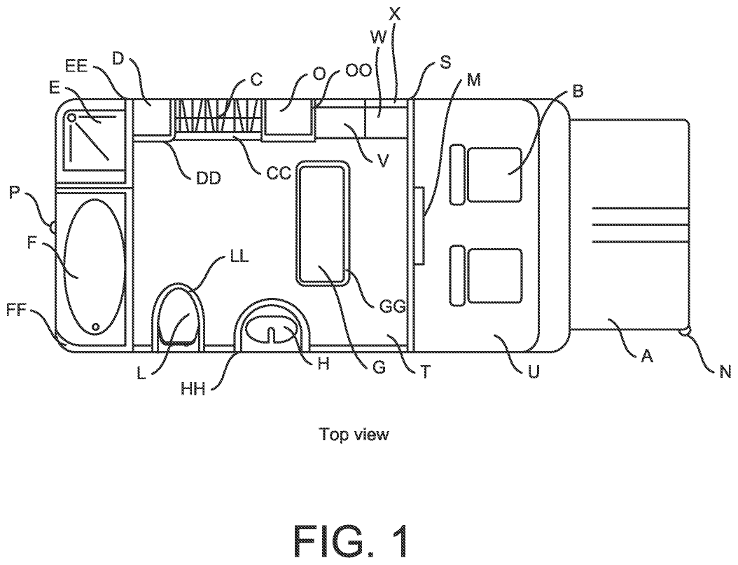

FIG. 1 is a top elevational view of Hygiene Mobile Van showing Hood referenced as A., Driver Seat referenced as B., Clothes Hanger referenced as C., closet sanitary cover as CC, Hygiene Cabinet referenced as D., hygiene cabinet sanitary cover as DD, Shower referenced as E., shower cover cover as EE, hot Tub/Jacuzzi referenced as F., hot tub/Jacuzzi as FF, Soft Bench referenced as G., soft bench sanitary cover as GG, Sink referenced as H., Sink sanitary cover as HH, Transferable Toilet referenced as L., transferable toilet sanitary cover as LL, 19″-24: TV (inside van) referenced at M., Side View Camera (for blind spots) referenced as N., Small Cabinet for Microwave and Mini Fridge referenced as O., small cabinet for microwave and mini fridge sanitary cover as OO, Rear view Camera referenced as P., in accordance with an embodiment of the present disclosure. Also depicted are the sanitary curtain S separating the cab U from the personal space in the hygiene mobile van, the whole floor sanitary cover T, the ultra-high temperature water heater V and the credit card/debit card reader W and cover thereof X.

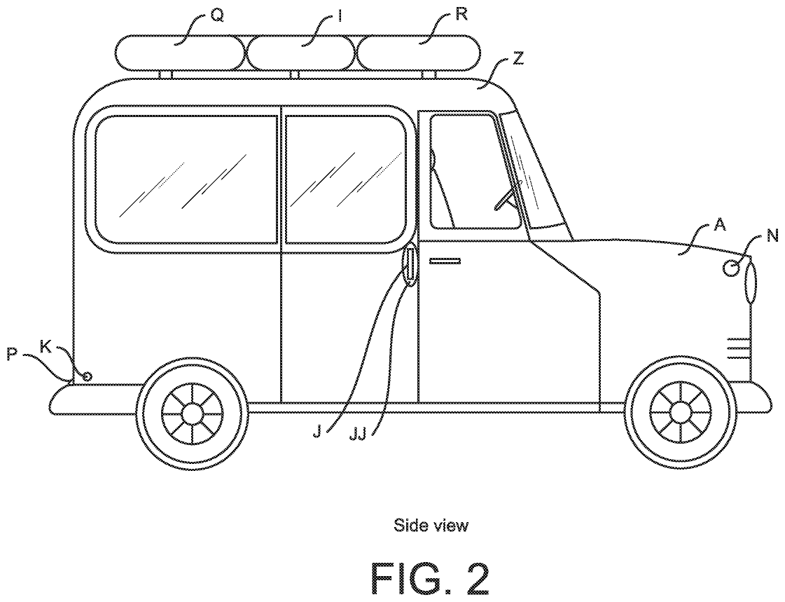

FIG. 2 is a side elevational view of Hygiene Mobile Van showing Hood referenced as A., roof as Z, a Water Supply Tank referenced as I., a filtered HVAC Q for the personal space over the floor sanitary cover T, the Door Latch referenced as J., and the door latch cover as JJ, Drainage referenced as K., Side View Camera (for blind spots) referenced as N., Rear view Camera referenced as P., and the cab U HVAC unit R in accordance with an embodiment of the present disclosure.

The present disclosed Hygiene Mobile Van, also known as “The Hospitality”, is a vehicle, commercial van that services the hygienic and productive needs of individuals while on the go. Expanding upon the initial concept of a recreational vehicle, The hospitality features seating for the driver and passengers, cabinetry, a hot tub, a shower a sink, a transferable toilet, dual flat-screen televisions, and side and rear-view cameras to eliminate any blind spots, during operation. In addition to the exceptional living quarters, The Hospitality is equipped with sufficient drainage for proper functionality and a supply tank capable of storing a hundred gallons of water. Furthermore, The Hospitality is a versatile vehicle crafted to operate in any environment under all conditions and ultimately serves to simplify movement and transport in these modern times as these features empowers users to having domestic necessities readily available in their vehicle. The Hospitality is an effective all-inclusive mobile unit for daily use or for extended travels.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A van vehicle comprising:
a sanitary curtain configured to hermetically seal off a front cab space from a personal hygiene space in an inside of the van vehicle;
a sanitary cover for each fomite in the personal hygiene space inside of the van vehicle, wherein a fomite having a water transfer there through defines a drain therein; and
a HVAC ventilation for the personal hygiene space separate from a HVAC ventilation for the front cab space.

2. The van vehicle of claim 1, further comprising a sanitary cover for a floor of the personal hygiene space.

3. The van vehicle of claim 1, wherein the sanitary cover for each fomite comprises a sanitary cover for a toilet seat in the personal hygiene space.

4. The van vehicle of claim 1, wherein the sanitary cover for each fomite comprises a sanitary cover for a sink rim in the personal hygiene space.

5. The van vehicle of claim 1, wherein the sanitary cover for each fomite comprises a sanitary cover for a shower including all four walls thereof in the personal hygiene space.

6. The van vehicle of claim 1, wherein the sanitary cover for each fomite comprises a sanitary cover for a bathtub rim in the personal hygiene space.

7. The van vehicle of claim 1, wherein the sanitary cover for each fomite comprises a sanitary cover for a soft bench in the personal hygiene space.

8. The van vehicle of claim 1, wherein the sanitary cover for each fomite comprises a sanitary cover for a clothes closet including three walls thereof.

9. The van vehicle of claim 1, wherein the sanitary cover for each fomite comprises a sanitary cover for a hygiene cabinet door handle in the personal hygiene space.

10. The van vehicle of claim 1, wherein the sanitary cover for each fomite comprises a sanitary cover for a countertop in the personal hygiene space.

11. The van vehicle of claim 1, further comprising a remote controlled television disposed on the front cab space side of the sanitary curtain.

12. The van vehicle of claim 1, further comprising a credit card and debit card reader and a sanitary cover therefore in the personal hygiene space.

13. The van vehicle of claim 1, further comprising a touchless toilet flush sensor and circuit in the personal hygiene space.

14. The van vehicle of claim 1, wherein the sanitary cover for each fomite comprises a sanitary cover for a toilet flush handle in the personal hygiene space.

15. The van vehicle of claim 1, wherein the sanitary cover for each fomite comprises a sanitary cover for a faucet handle in the personal hygiene space.

16. The van vehicle of claim 1, further comprising a touchless faucet control sensor and circuit in the personal hygiene space.

17. The van vehicle of claim 1, wherein each sanitary cover comprises a tacky semi-adhesive substance disposed on a contact side thereof.

18. The van vehicle of claim 1, wherein each sanitary cover comprises a self-adhesive disposed on a contact side thereof with the personal hygiene space.

19. The van vehicle of claim 1, further comprising a self-test pathogen station in the personal hygiene space.

20. The van vehicle of claim 1, further comprising a double filtered ventilation system in the personal hygiene space separate from a filtered ventilation system for the front cab space.
